(19) United States
(12) Patent Application Publication
(10) Pub. No.: US 2007/0257864 A1
(43) Pub. Date: Nov. 8, 2007

(54) Plasma display device and method of driving PDP

(76) Inventors: Sun Hong Lee, Kyungsangbuk-do (KR); Do Yoon Kim, Kyungsangbuk-do (KR)

Correspondence Address: KED & ASSOCIATES, LLP, P.O. Box 221200, Chantilly, VA, 20153-1200, US

(21) Appl. No.: 11/797,715

(22) Filed: May 7, 2007

(30) Foreign Application Priority Data
May 8, 2006 (KR) 10-2006-0041017

(51) Int. Cl. G09G 3/28

(52) U.S. Cl. 345/67

(57) ABSTRACT

A plasma display device and a method of driving a plasma display panel (PDP) are provided. The plasma display device includes an upper substrate on which a plurality of first electrodes and a plurality of second electrodes respectively corresponding to the first electrodes are formed; and a lower substrate on which a plurality of third electrodes are formed, wherein the first electrodes are respectively 100 μm or more distant apart from the second electrodes, and during a reset period, a voltage that gradually increases is applied to the first electrodes, and at the same time, a positive bias voltage is applied to the third electrodes. Therefore, it is possible to reduce the power consumption of a PDP by driving a PDP including a scan electrode and an address electrode that are sufficiently distant apart from each other in such a manner that a positive bias voltage can be applied to an address electrode during a reset period. In addition, it is possible to improve the luminance of a PDP and the quality of display of images by preventing a misdischarge such as a spot. Moreover, it is possible to prevent a panel driving circuit from malfunctioning and to improve the reliability of a panel driving circuit by applying a positive bias voltage to a plurality of address electrodes at at least two different times so that noise in driving signals can be reduced.

This application claims priority from Korean Patent Application No. 10-2006-0041017 filed on May 8, 2006 in the Korean Intellectual Property Office, the disclosure of which is incorporated herein by reference in its entirety.

### BACKGROUND OF THE INVENTION

1. Field of the Invention

The present invention relates to a plasma display device, and more particularly, to a method of effectively driving a plasma display panel (PDP) and a plasma display device using the method.

2. Description of the Related Art

Plasma display panels (PDPs) are display devices which display an image by applying a predetermined voltage to a number of electrodes installed in a discharge space to cause a gas discharge and then exciting phosphors with the aid of plasma that is generated as a result of the gas discharge. PDPs are easy to manufacture as large-dimension thin flat displays. In addition, PDPs can provide high luminance and high light emission efficiency, compared to other flat panel displays.

In the meantime, a PDP is driven in a time-division manner using a reset period for initializing all discharge cells, an address period for selecting a number of discharge cells, and a sustain period for enabling the selected discharge cells to cause a sustain discharge. A reset period is generally divided into a set-up period during which a gradual voltage increase from a first voltage to a second voltage occurs, a descending period during which a rapid voltage decrease from the second voltage to a third voltage occurs, and a set-down period during which a gradual voltage decrease from the third voltage to a fourth voltage occurs.

Conventional PDPs are likely to cause a misdischarge (such as a spot) during a reset period, thereby deteriorating the quality of display of images.

### SUMMARY OF THE INVENTION

The present invention provides a plasma display device and a method of driving a plasma display panel (PDP) which can improve the quality of display of images and reduce power consumption by reducing the probability of occurrence of a misdischarge such as a spot.

According to an aspect of the present invention, there is provided a plasma display device which is driven in a time-division manner by dividing each frame into a plurality of sub-fields, the plasma display device including an upper substrate on which a plurality of first electrodes and a plurality of second electrodes respectively corresponding to the first electrodes are formed; and a lower substrate on which a plurality of third electrodes are formed, wherein the first electrodes are respectively 100 μm or more distant apart from the second electrodes, and during a reset period, a voltage that gradually increases is applied to the first electrodes, and at the same time, a positive bias voltage is applied to the third electrodes.

According to another aspect of the present invention, there is provided a method of driving a PDP in a time-division manner by dividing each frame into a plurality of sub-fields, the PDP comprising an upper substrate on which a plurality of first electrodes and a plurality of second electrodes respectively corresponding to the first electrodes are formed and a lower substrate on which a plurality of third electrodes are formed, the first electrodes being respectively 100 μm or more distant apart from the second electrodes, and the method including, during a reset period, applying a voltage that gradually increases to the first electrodes, and at the same time, applying a positive bias voltage to the third electrodes.

### BRIEF DESCRIPTION OF THE DRAWINGS

The above and other features and advantages of the present invention will become more apparent by describing in detail preferred embodiments thereof with reference to the attached drawings in which:

FIG. 1 is a perspective view of a plasma display panel (PDP);

FIGS. 2 through 5 are cross-sectional views of a PDP;

FIG. 6 illustrates the arrangement of electrodes in a PDP;

FIG. 7 is a timing diagram for explaining a time-division method of driving a PDP in which a frame is divided into a plurality of sub-fields;

FIG. 8 is a timing diagram illustrating the waveforms of driving signals used to drive a PDP, according to an embodiment of the present invention;

FIG. 9 is a timing diagram illustrating the waveforms of driving signals used to drive a PDP, according to another embodiment of the present invention; and

FIGS. 10 and 11 are timing diagrams for explaining methods of applying a signal to a plurality of address electrodes at different times by appropriately delaying the signal.

### DETAILED DESCRIPTION OF THE INVENTION

The present invention will hereinafter be described in detail with reference to the accompanying drawings in which exemplary embodiments of the invention are shown.

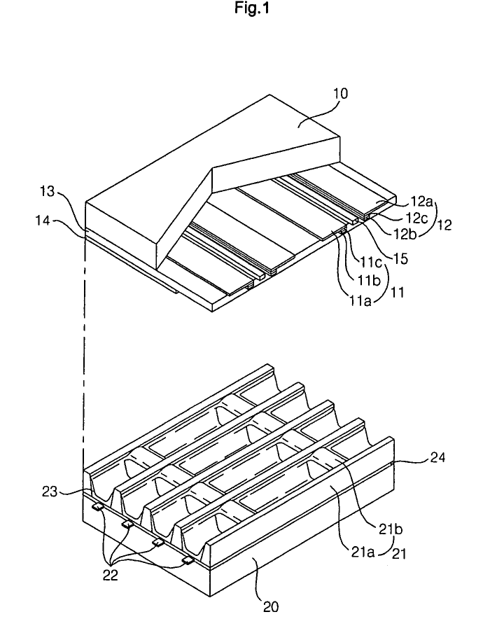

FIG. 1 is a perspective view of a plasma display panel (PDP). Referring to FIG. 1, the PDP includes a sustain electrode pair which is formed on an upper substrate 10 and an address electrode 22 which is formed on a lower substrate 20. The sustain electrode pair includes a scan electrode 11 and a sustain electrode 12.

The scan electrode 11 may include a transparent electrode 11a and a bus electrode 11b, and the sustain electrode 12 may include a transparent electrode 12a and a bus electrode 12b. The transparent electrodes 11a and 12a may be formed of indium tin oxide (ITO). The bus electrodes 11b and 12b may be formed of a metal such as silver (Ag) or chromium (Cr), a chromium/copper/chromium (Cr/Cu/Cr) stack, or a chromium/aluminum/chromium (Cr/Al/Cr) stack. The bus electrodes 11b and 12b are respectively disposed on the transparent electrodes 11a and 12a and can reduce a voltage drop caused by the transparent electrodes 11a and 12a which have high resistance.

The distance between the scan electrode 11 and the sustain electrode 12, particularly, the distance between the transparent electrodes 11a and 121a, may be set to 100 μm or more. By doing so, it is possible to increase the aperture ratio of a PDP, enhance the brightness of a PDP, reduce the power consumption of a PDP, and improve the efficiency of driving a PDP. Since the scan electrode 11 and the sustain electrode 12 are sufficiently distant apart from each other, the scan electrode 11 and the sustain electrode 12 may overlap a horizontal barrier rib 21b. The maximum distance between the scan electrode 11 and the sustain electrode 12 may be the same as the width of the horizontal barrier rib 21b.

According to an embodiment of the present invention, the sustain electrode pair 11 and 12 can be composed of a stacked structure of the transparent electrodes 11a 12a and the bus electrodes 11b and 12b or only the bus electrodes 11b and 12b without the transparent electrodes 11a and 12a. Because the latter structure does not use the transparent electrodes 11a and 12a, a cost of manufacturing a panel can be decreased. The bus electrodes 11b and 12b that are used in the structure can be made of various materials such as a photosensitive material in addition to the above-described materials.

In order to improve luminance and to reduce power consumption, the distance between the bus electrodes 11b and 12b may be 100 μm or more.

A black matrix BM 15, which performs a light blocking function of reducing reflection by absorbing external light that is generated from the outside of the upper substrate 10 and a function of improving purity and contrast of the upper substrate 10 is arranged between the transparent electrodes 11a and 12a and the bus electrodes 11b and 12b of the scan electrode 11 and the sustain electrode 12.

The black matrix 15 according to an embodiment of the present invention is formed on the upper substrate 10 and includes a first black matrix 15 that is formed in a position that is overlapped with a barrier rib 21 and second black matrixes 11c and 12c that are formed between the transparent electrodes 11a and 12a and the bus electrodes 11b and 12b. Here, the first black matrix 15 and the second black matrixes 11c and 12c that are also referred to as a black layer or a black electrode layer may be physically connected to each other when they are formed at the same time in a forming process or may be not physically connected to each other when they are not formed at the same time.

Furthermore, when they are physically connected to each other, the first black matrix 15 and the second black matrixes 11c and 12c are made of the same material, but when they are physically separated from each other, they may be made of other materials.

An upper dielectric layer 13 and a protective film 14 are stacked in the upper substrate 10 in which the scan electrode 11 and the sustain electrode 12 are formed in parallel. Charged particles, which are generated by a discharge are accumulated in the upper dielectric layer 13 and perform a function of protecting the sustain electrode pair 11 and 12. The protective film 14 protects the upper dielectric layer 13 from sputtering of charged particles that are generated at a gas discharge and enhances emission efficiency of a secondary electron.

The scan electrode 11 and the sustain electrode 12 may be formed on a black layer, instead of being placed in direct contact with the upper substrate 10. In other words, a black layer may be interposed between the upper substrate 10 and the scan electrode 11 and between the upper substrate 10 and the sustain electrode 12, thereby preventing the upper substrate 10 from being discolored due to being in direct contact with the scan electrode 11 and the sustain electrode 12.

Furthermore, the address electrode 22 is formed in an intersecting direction of the scan electrode 11 and the sustain electrode 12. Furthermore, a lower dielectric layer 24 and a barrier rib 21 are formed on the lower substrate 20 in which the address electrode 22 is formed.

Furthermore, a phosphor layer 23 is formed on the surface of the lower dielectric layer 24 and the barrier rib 21. In the barrier rib 21, a vertical barrier rib 21a and the horizontal barrier rib 21b are formed in a closed manner and the barrier rib 21 physically divides a discharge cell and prevents ultraviolet rays and visible light that are generated by a discharge from leaking to adjacent discharge cells.

In an embodiment of the present invention, various shapes of barrier rib structures, other than the barrier rib 21 structure shown in FIG. 1, can be used. For example, a differential barrier rib structure in which the vertical barrier rib 21a and the horizontal barrier rib 21b have different heights, a channel type barrier rib structure in which a channel, which can be used as an exhaust passage is formed in at least one of the vertical barrier rib 21a and the horizontal barrier rib 21b, and a hollow type barrier rib structure in which a hollow is formed in at least one of the vertical barrier rib 21a and the horizontal barrier rib 21b, can be used.

In the differential type barrier rib structure, it is more preferable that a height of the horizontal barrier rib 21b is higher than that of the vertical barrier rib 21a and in the channel type barrier rib structure or the hollow type barrier rib structure, it is preferable that a channel or a hollow is formed in the horizontal barrier rib 21 b.

In an embodiment of the present invention, it is described as each of R, G, and B discharge cells is arranged on the same line, but they may be arranged in other shapes. For example, delta type of arrangement in which the R, G, and B discharge cells are arranged in a triangle shape may be also used. Furthermore, the discharge cell may have various polygonal shapes such as a quadrilateral shape, a pentagonal shape, and a hexagonal shape.

Furthermore, the phosphor layer 23 emits light by ultraviolet rays that are generated at a gas discharge and generates any one visible light among red color R, green color G, or blue color B light. Here, inert mixed gas such as He+Xe, Ne+Xe, and He+Ne+Xe for performing a discharge is injected into a discharge space that is provided between the upper and lower substrates 10 and 20 and the barrier rib 21.

According to an embodiment of the present invention, R, G, and B discharge cells may have the same pitch. Alternatively, R, G, and B discharge cells may have different pitches in order to harmonize the color temperatures of R, G, and B discharge cells. More specifically, R, G, and B discharge cells may have different pitches from one another or only one of R, G, and B discharge cells may have a different pitch from the other discharge cells. For example, the pitch of an R discharge cell may be smallest, and the pitches of G and B discharge cells may be larger than the pitch of an R discharge cell.

The address electrode 22, which is formed on the lower substrate 20, may have a uniform width or thickness. Alternatively, the width/thickness of the address electrode 22 may differ from one portion to another portion of the address electrode 22. For example, the width/thickness of the address electrode 22 may be greater inside a discharge cell than outside the discharge cell.

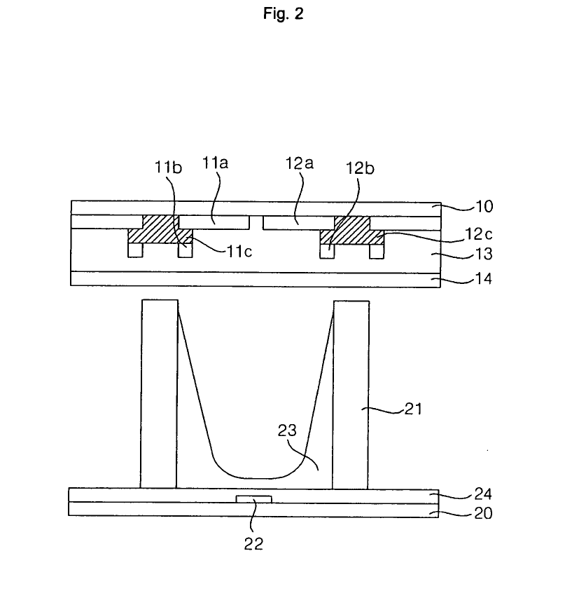

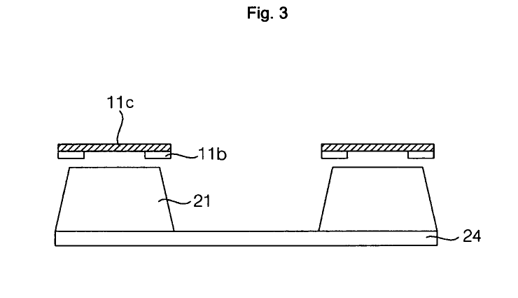

FIGS. 2 and 3 are cross-sectional views of a PDP according to an embodiment of the present invention. Referring to FIGS. 2 and 3, a black matrix 11c is disposed between an ITO transparent electrode 11a and a bus electrode 11b, and a black matrix 12c is disposed between an ITO transparent electrode 12a and a bus electrode 12b. The black matrix 11c and the bus electrode 11b may be formed in one body, and the black matrix 12c and the bus electrode 12b may be formed in one body.

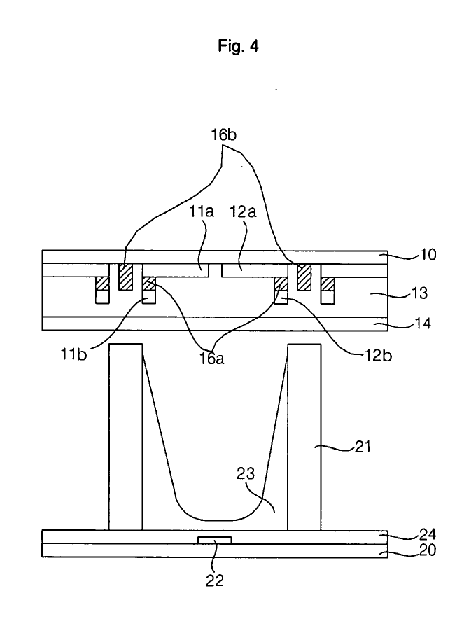

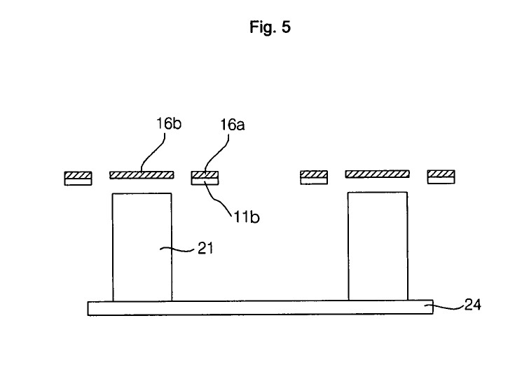

FIGS. 4 and 5 are cross-sectional views of a PDP according to another embodiment of the present invention. Referring to FIGS. 4 and 5, a black matrix is divided into a first black matrix 16a which is interposed between an ITO transparent electrode 11a and a bus electrode 11b or between an ITO transparent electrode 12a and a bus electrode 12b and a second black matrix 16b which is superimposed on a barrier rib 21. Isolation-type black matrices such as those illustrated in FIG. 3 can improve the luminance of a PDP by enhancing the emission of panel light generated by a discharge.

Referring to FIG. 5, the bus electrode 11b may be disposed inside a discharge cell so that the bus electrode 11b can be prevented from overlapping the barrier rib 2]1. This type of bus structure is referred to as an in-bus structure. The in-bus structure can reduce a discharge initiation voltage and can thus reduce the amount of power required to drive a PDP.

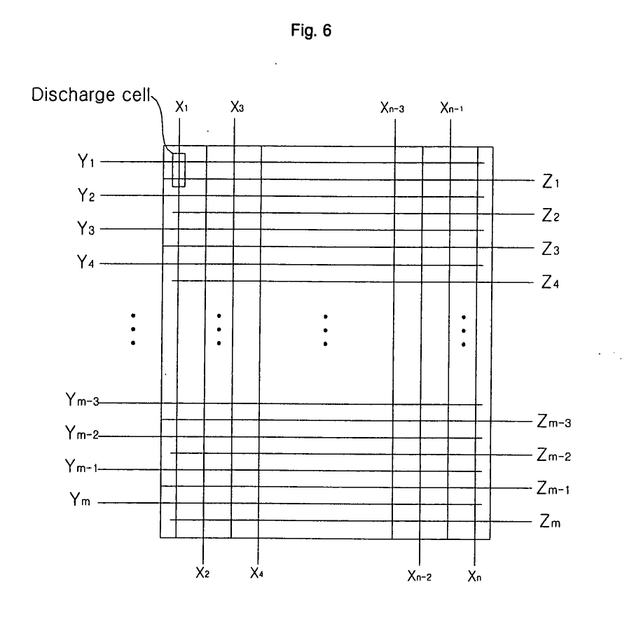

FIG. 6 illustrates the arrangement of electrodes in a PDP. Referring to FIG. 6, a plurality of discharge cells that constitute a PDP may be arranged in a matrix. The discharge cells are respectively disposed at the intersections between a plurality of scan electrode lines Y₁ through Yₘ and a plurality of address electrode lines X₁ through Xₘ or the intersections between a plurality of sustain electrode lines Z₁ through Zₘ and the address electrode lines X₁ through Xₙ. The scan electrode lines Y₁ through Yₘ may be sequentially or simultaneously driven. The sustain electrode lines Z₁ through Zₘ may be simultaneously driven. The address electrode lines X₁ through Xₙ may be divided into two groups: a group including odd-numbered address electrode lines and a group including even-numbered address electrode lines. The address electrode lines X₁ through Xₙ may be driven in units of the groups or may be sequentially driven.

The electrode arrangement illustrated in FIG. 6, however, is exemplary, and thus, the present invention is not restricted to this. For example, the scan electrode lines Y₁ through Yₘ may be driven using a dual scan method or a double scan method in which two of a plurality of scan lines are driven at the same time. More specifically, the dual scan method is characterized by dividing a PDP into upper and lower areas and driving a scan electrode line selected from the upper area and a scan electrode line selected from the lower area at the same time. The double scan method is characterized by driving a-pair of adjacent scan electrode lines at the same time.

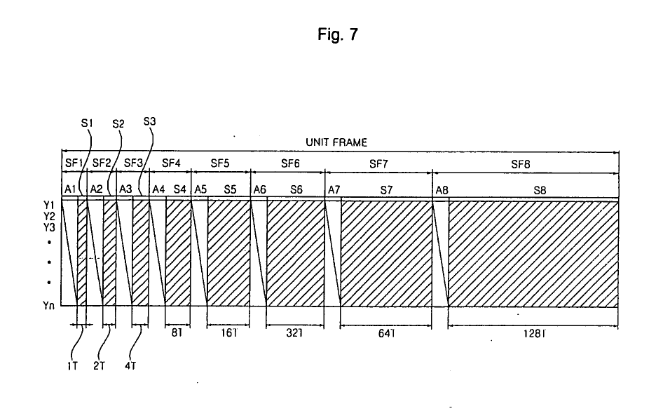

FIG. 7 is a timing diagram for explaining a time-division method of driving a PDP in which a frame is divided into a plurality of sub-fields. Referring to FIG. 7, a unit frame is divided into a predefined number of sub-fields, for example, eight sub-fields SF1 through SF8, in order to realize a time-division grayscale display. Each of the sub-fields SF1 through SF8 is divided into a reset period (not shown), an address period (A1, . . . , A8), and a sustain period (S1, . . . , S8).

Not all of the sub-fields SF1 through SF8 may have a reset period. For example, only the first sub-field SF1 may have a reset period, or only the first sub-field and a middle sub-field may have a reset period.

During each of the address periods A1 through A8, a display data signal is applied to an address electrode X, and a scan pulse is supplied to a scan electrode Y so that wall charges can be generated in a discharge cell.

During each of the sustain periods S1 through S8, a sustain pulse is alternately supplied to the scan electrode Y and a sustain electrode Z so that a discharge cell can cause a number of sustain discharges.

The luminance of a PDP is proportional to the total number of sustain discharge pulses allocated throughout the sustain discharge periods S1 through S8. Assuming that a frame for one image includes eight sub-fields and is represented with 256 grayscale levels, 1, 2, 4, 8, 16, 32, 64, and 128 sustain pulses may be respectively allocated to the sustain periods S1, S2, S3, S4, S5, S6, S7, and S8. In order to obtain luminance corresponding to a grayscale level of 133, a plurality of discharge cells may be addressed during the first, third, and eighth sub-fields SF1, SF3, and SF8 so that they can cause a total of 133 sustain discharges.

The number of sustain discharges allocated to each of the sub-fields SF1 through SF8 may be determined according to a weight allocated to a corresponding sub-field through automatic power control (APC). Referring to FIG. 7, a frame is divided into eight sub-fields, but the present invention is not restricted to this. In other words, the number of sub-fields in a frame may be varied. For example, a PDP may be driven by dividing each frame into more than eight sub-fields (e.g., twelve or sixteen sub-fields).

The number of sustain discharges allocated to each of the sub-fields SF1 through SF8 may be varied according to gamma and other characteristics of a PDP. For example, a grayscale level of 6, instead of a grayscale level of 8, may be allocated to the sub-field SF4, and a grayscale level of 34, instead of a grayscale level of 32, may be allocated to the sub-field SF6.

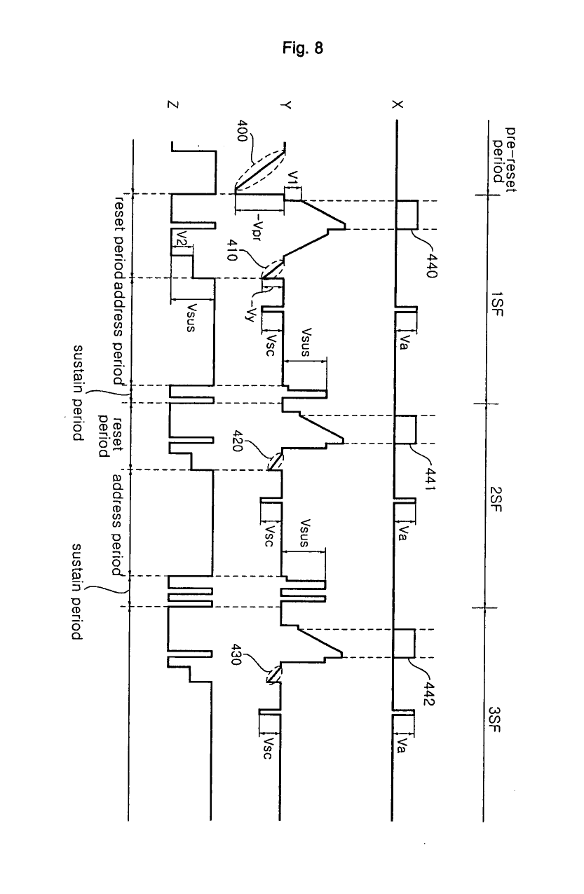

FIG. 8 is a timing diagram illustrating the waveforms of driving signals used to drive a PDP, according to an embodiment of the present invention. Referring to FIG. 8, a pre-reset period is followed by a first sub-field. During the pre-reset period, positive wall charges are generated on a scan electrode Y and negative wall charges are generated on a sustain electrode Z. Each sub-field includes a reset period for initializing discharge cells of a previous frame with reference to the distribution of wall charges generated during the pre-reset period, an address period for selecting a number of discharge cells, and a sustain period for enabling the selected discharge cells to cause a number of sustain discharges.

A reset period includes a set-up period during which a voltage gradually increases, a descending period during which a voltage rapidly decreases, and a set-down period during which a voltage gradually decreases. During a set-up period, a set-up signal whose voltage gradually increases is applied to the scan electrodes of all discharge cells at the same time so that each of the discharge cells can cause a weak set-up discharge, and that wall charges can be generated in the discharge cells.

Referring to FIG. 8, a signal whose voltage rapidly increases by V1 may be applied to the scan electrode Y, where V1 may be the same as a scan voltage Vsc applied to the scan electrode Y during an address period.

During a set-down period, a set-down signal whose voltage gradually decreases is applied to the scan electrode Y, thereby causing an erase discharge. As a result of the erase discharge, the wall charges generated by the set-up discharge and unnecessary space charges are erased.

During the application of the set-up signal to the scan electrode Y, an opposing discharge may occur between an address electrode X and the scan electrode Y. Due to the opposing discharge, a misdischarge such as a spot may occur, and thus, the quality of display of images may deteriorate. Since the distance between a pair of adjacent ITO electrodes is set to be 100 μm or more, a discharge initiation voltage required to cause a discharge between the scan electrode Y and the sustain electrode Z increases, and thus, an opposing discharge between the scan electrode Y and the address electrode X is more likely to occur than a surface discharge between the scan electrode Y and the sustain electrode Z.

Therefore, positive bias voltages 440, 441, and 442 may be applied to the address electrode X during the application of the set-up signal to the scan electrode Y.

When a positive voltage is supplied to the address electrode X, a repulsive force is generated between the address electrode X and the scan electrode to which the set-up signal is applied, thereby reducing the probability of an opposing discharge occurring between the scan electrode Y and the address electrode X.

As described above, when the distance between the scan electrode Y and the sustain electrode Z (particularly, the distance between a pair of adjacent ITO electrodes) is 100 μm or more, a surface discharge can be stably generated between the scan electrode Y and the sustain electrode Z by supplying a positive bias voltage to the address electrode X.

The bias voltages 440, 441, and 442 may be the same as an address voltage Va which is applied to the address electrode X during an address period.

Referring to FIG. 8, a descending signal 410 whose voltage gradually decreases may be applied to the scan electrode before an address period. A lowest voltage −Vpr of a descending signal 400 which is applied to the scan electrode Y during the pre-reset period may be lower than a lowest voltage −Vy of the descending signal 410.

During the application of the descending signal 410 to the scan electrode Y, a positive voltage V2 may be applied to the sustain electrode Z. The positive voltage V2 may be half of a voltage Vsus applied to the sustain electrode Z during an address period.

A panel driving device according to an embodiment of the present invention may include a source capacitor Cs which collects energy supplied to a PDP and stores the collected energy in order to supply a sustain pulse to the PDP, an energy supply switch ER_up which is turned on so that the energy stored in the source capacitor Cs can be supplied to the scan electrode Y, and an inductor which constitutes an oscillation circuit.

The positive voltage V2, which is applied to the sustain electrode Z during a reset period, may be generated using the energy stored in the source capacitor Cs.

During an address period, a negative scan signal having the same voltage as the scan voltage Vsc is applied to the scan electrode Y, and a positive data signal is applied to the address electrode X. Due to the wall charges generated during a reset period and the difference between the negative scan signal and the positive data signal, an address discharge occurs, and a cell is selected. During a set-down period and an address period, a signal whose voltage is maintained to be the same as the sustain voltage Vsus is applied to the sustain electrode Z.

During a sustain period, a sustain signal having the same voltage as the sustain voltage Vsus is alternately applied to the scan electrode Y and the sustain electrode Z so that a surface discharge can occur between the scan electrode Y and the sustain electrode Z as a sustain discharge.

The waveforms illustrated in FIG. 8 are exemplary, and thus, the present invention is not restricted thereto. For example, a pre-reset period may be optional. In addition, the polarities and voltages of driving signals used to drive a PDP are not restricted to those illustrated in FIG. 8, and may be altered in various manners. An erase signal for erasing wall charges may be applied to the sustain electrode Z after a sustain discharge. The sustain signal may be applied to only one of the scan electrode Y and the sustain electrode Z, thereby realizing a single-sustain driving method.

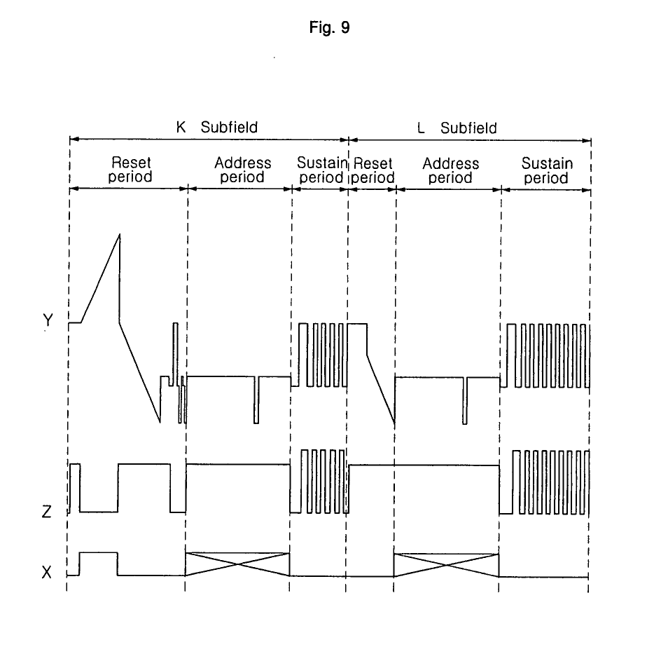

FIG. 9 is a timing diagram illustrating the waveforms of driving signals used to drive a PDP, according to another embodiment of the present invention. Referring to FIG. 9, during a reset period of a K-th sub-field, which is one of a plurality of sub-frames of a frame, a set-up signal whose voltage gradually increases and a set-down signal whose voltage gradually decreases may be applied to a scan electrode Y. During a set-up period, a positive-bias voltage may be applied to an address period X in order to prevent a misdischarge.

During a set-up period, a set-up discharge occurs in all discharge cells so that wall charges can accumulate in the discharge cells. During a set-down period, a set-down signal whose voltage gradually decreases is applied so that a weak erase discharge can occur. Due to the erase discharge, sufficient wall charges to stably cause an address discharge can uniformly remain in the discharge cells. During one of a plurality of sub-fields of a frame, a stabilization signal having a positive voltage and/or a negative voltage may also be applied before the application of a scan signal in order to stabilize a discharge. The stabilization signal can guarantee a stable address discharge by establishing a sufficient wall charge state to cause an address discharge in the discharge cells.

During an address period of the K-th sub-field, a scan signal is applied to the scan electrode Y and a positive data signal which is synchronized with the scan signal is applied to the address electrode X. Due to the difference between the scan signal and the positive data signal and a wall voltage generated during the reset period of the K-th sub-field, an address discharge occurs in a discharge cell so that wall charges necessary for causing a sustain discharge can be generated in the discharge cell.

During a sustain period of the K-th sub-field, a sustain signal is alternately applied to the scan electrode Y and a sustain electrode Z. Then, a sustain discharge, i.e., a display discharge, occurs in a discharge cell selected by the address discharge whenever the sustain signal is applied to the discharge cell.

An L-th sub-field, like the K-th sub-field, includes a reset period, an address period, and a sustain period. Almost the same driving signals as those applied during the reset-period, the address period, and the sustain period of the K-th sub-field are applied during the reset period, the address period, and the sustain period of the L-th sub-field.

During the reset period of the L-th sub-field, unlike during the reset period of the K-th sub-field, no positive voltage may be applied after a set-up period and no negative voltage may be applied after a set-down period in order to secure sufficient timing margins to drive a PDP. In short, a positive voltage and a negative voltage may not necessarily be applied in every sub-field of a frame, but may be selectively applied in some of a plurality of sub-fields of a frame.

During the reset period of the L-th sub-field, unlike the reset period of the K-th sub-field, a set-up signal whose voltage gradually increases may not be applied. In this case, during the reset period of the L-th sub-field, no positive bias voltage may be applied to the address electrode X.

At least two of a plurality of scan electrodes may differ from each other in terms of the length of at least one of a reset period, an address period, and a sustain period of a sub-field. If a reset period of a sub-field is divided into a set-up period and a set-down period, at least two of a plurality of scan electrodes may differ from each other in terms of the length of at least one of the set-up period and the set-down period.

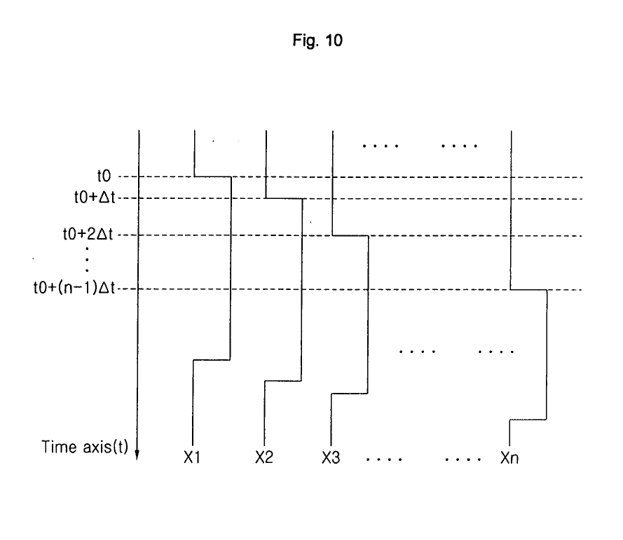

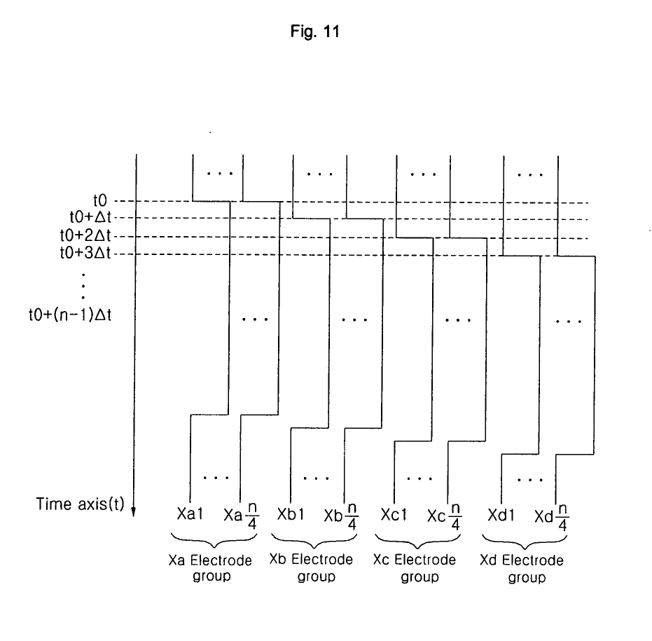

FIGS. 10 and 11 are timing diagrams for explaining methods of applying a signal to a plurality of address electrodes at different times by appropriately delaying the signal.

According to the embodiment of FIGS. 8 and 9, during a reset period, a set-up signal whose voltage gradually increases is applied to a plurality of scan electrodes and at the same time, a positive bias voltage is applied to a plurality of address electrodes. If the positive bias voltage is applied to the address electrodes at the same time, noise may be generated in the waveforms of driving signals applied to the scan electrodes and a plurality of sustain electrodes.

Such noise is generated due to coupling caused by the capacitance of a PDP. When a positive bias voltage applied to the address electrodes rapidly increases, ascending noise may be generated in driving signals applied to the scan electrodes Y and the sustain electrodes. On the other hand, when the positive bias voltage rapidly decreases, descending noise may be generated in the driving signals applied to the scan electrodes and the sustain electrodes.

Referring to FIG. 10, in order to reduce noise in driving signals, a positive bias voltage may be applied to a plurality of address electrodes X₁ through Xₙ at different times. For example, the positive bias voltage may be applied to the first address electrode X₁ at a time t0, to the second address electrode X₂ at a time t0+Δt, and to the n-th address electrode Xₙ at a time t0+(n−1)Δt.

Assuming that the positive bias voltage is applied to an m-th address electrode at a time tm (1≦m≦n−1) and is applied to an (m+1)-th address electrode at a time t(m+1), an interval Δt between the time tm and the time t(m+1) may be uniform or variable.

More specifically, the interval Δt may have two or more values. For example, the positive bias voltage may be applied to the first address electrode X₁ at 10 ns, to the second address electrode X₂ at 20 ns, and to the third address electrode X₃ at 40 ns.

The interval Δt may be within the range of 10 ns to 1000 ns. The interval Δt may be 1/10- 1/100 of an entire scan period for driving a PDP. In short, it is possible to reduce noise in driving signals applied to scan electrodes and sustain electrodes by applying a bias voltage to-address electrodes at different times during a reset period so that the probability of occurrence of coupling due to the capacitance of a PDP can be reduced.

Referring to FIG. 10, a positive bias voltage is applied to the address electrodes X₁ through Xₙ at different times. However, a predefined number of address electrodes may be supplied with the positive bias voltage at the same time, where the predefined number is within the range of 2 to (n−1).

Referring to FIG. 11, a plurality of address electrodes are divided into a plurality of electrode groups Xₐ, X_{b}, X_{c} and X_{d}. Then, a positive bias voltage is applied to the address electrodes so that the electrode groups Xₐ, X_{b}, X_{c} and X_{d} can differ from one another in terms of when they are supplied with the positive bias voltage.

For example, a bias voltage may be applied to the electrode group Xₐ at a time t0, to the electrode group X_{b} at a time t0+Δt, to the electrode group X_{c} at a time t0+2Δt, and to the electrode group X_{d} at a time t0+3Δt.

An interval At between when the bias voltage is applied to an m-th electrode group (1≦m≦n−1) and when the bias voltage is applied to an (m+1)-th electrode group may be uniform or variable.

As described above, according to the present invention, it is possible to reduce the power consumption of a PDP by driving a PDP including a scan electrode and an address electrode that are sufficiently distant apart from each other in such a manner that a positive bias voltage can be applied to an address electrode during a reset period. In addition, it is possible to improve the luminance of a PDP and the quality of display of images by preventing a misdischarge such as a spot. Moreover, it is possible to prevent a panel driving circuit from malfunctioning and to improve the reliability of a panel driving circuit by applying a positive bias voltage to a plurality of address electrodes at at least two different times so that noise in driving signals can be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display device which is driven in a time-division manner by dividing each frame into a plurality of sub-fields, the plasma display device comprising:
an upper substrate on which a plurality of first electrodes and a plurality of second electrodes respectively corresponding to the first electrodes are formed; and
a lower substrate on which a plurality of third electrodes are formed,
wherein the first electrodes are respectively 100 μm or more distant apart from the second electrodes, and during a reset period, a voltage that gradually increases is applied to the first electrodes, and at the same time, a positive bias voltage is applied to the third electrodes.

2. The plasma display device of claim 1, wherein each of the first and second electrodes comprises an indium tin oxide (ITO) electrode and a bus electrode, and the ITO electrodes of the first electrodes are respectively 100 μm or more distant apart from the ITO electrodes of the second electrodes.

3. The plasma display device of claim 1, wherein at least two of the third electrodes differ from each other in terms of when they are supplied with the positive bias voltage.

4. The plasma display device of claim 1, wherein the third electrodes are divided into one or more electrode groups, and the electrode groups differ from each other in terms of when they are supplied with the bias voltage.

5. The plasma display device of claim 4, wherein the electrode groups comprise first and second electrode groups, and an interval between when the first electrode group is supplied with the bias voltage and when the second electrode group is supplied with the bias voltage is 10 ns-1000 ns.

6. The plasma display device of claim 1, wherein, during a part of the plurality of sub-fields, a predetermined voltage that gradually increases is applied to the first electrodes and a bias voltage having the same polarity as the predetermined voltage is applied to the third electrodes.

7. The plasmas display device of claim 1, wherein, during a time period between when the bias voltage is applied and when a scan signal is applied, a stabilization signal having a positive voltage and/or a negative voltage is applied to the first electrodes.

8. The plasma display device of claim 1, wherein a pre-reset period for generating wall charges having opposite polarities in the first and second electrodes is followed by the first sub-field, a lowest voltage applied to the first electrodes during the pre-reset period is lower than a lowest voltage applied to the first electrodes during the reset period.

9. The plasma display device of claim 1, wherein, during a reset period, a negative voltage that gradually decreases is applied to the first electrodes, and at the same time, a first positive bias voltage is applied to the second electrodes, and during an address period, a second positive bias voltage is applied to the second electrodes, the first positive bias voltage being half of the second positive bias voltage.

10. The plasma display device of claim 9, further comprising a capacitor which collects energy from a plasma display panel (PDP) and stores the collected energy during a sustain period,
wherein the first positive bias voltage applied to the second electrodes is generated using the energy stored in the capacitor.

11. A method of driving a PDP in a time-division manner by dividing each frame into a plurality of sub-fields, the PDP comprising an upper substrate on which a plurality of first electrodes and a plurality of second electrodes respectively corresponding to the first electrodes are formed and a lower substrate on which a plurality of third electrodes are formed, the first electrodes being respectively 100 μm or more distant apart from the second electrodes, and the method comprising:
during a reset period, applying a voltage that gradually increases to the first electrodes, and at the same time, applying a positive bias voltage to the third electrodes.

12. The method of claim 11, wherein each of the first and second electrodes comprises an indium tin oxide (ITO) electrode and a bus electrode, and the ITO electrodes of the first electrodes are respectively 100 μm or more distant apart from the ITO electrodes of the second electrodes.

13. The method of claim 11, wherein at least two of the third electrodes differ from each other in terms of when they are supplied with the bias voltage.

14. The method of claim 11, wherein the third electrodes are divided into one or more electrode groups, and the electrode groups differ from each other in terms of when they are supplied with the bias voltage.

15. The method of claim 14, wherein the electrode groups comprise first and second electrode groups, and an interval between when the first electrode group is supplied with the bias voltage and when the second electrode group is supplied with the bias voltage is 10 ns-1000 ns.

16. The method of claim 11, wherein, during a part of the plurality of sub-fields, a predetermined voltage that gradually increases is applied to the first electrodes and a bias voltage having the same polarity as the predetermined voltage is applied to the third electrodes.

17. The method of claim 11, wherein, during a time period between when the bias voltage is applied and when a scan signal is applied, a stabilization signal having a positive voltage and/or a negative voltage is applied to the first electrodes.

18. The method of claim 11, wherein a pre-reset period for generating wall charges having opposite polarities in the first and second electrodes is followed by the first sub-field, a lowest voltage applied to the first electrodes during the pre-reset period is lower than a lowest voltage applied to the first electrodes during the reset period.

19. The method of claim 11, wherein, during a reset period, a negative voltage that gradually decreases is applied to the first electrodes, and at the same time, a first positive bias voltage is applied to the second electrodes, and during an address period, a second positive bias voltage is applied to the second electrodes, the first positive bias voltage being half of the second positive bias voltage.

20. The method of claim 19, wherein the first positive bias voltage applied to the second electrodes is generated using energy that is collected from the PDP and then stored in a capacitor during a sustain period.
